(19) United States
(12) Patent Application Publication
(10) Pub. No.: US 2019/0189300 A1
(43) Pub. Date: Jun. 20, 2019

(54) RADIATION SHIELDNG ELEMENT WITH AN INTEGRATED REPLACEMENT INDICATOR

(71) Applicant: SMITHS HEIMANN GMBH, Wiesbaden (DE)

(72) Inventor: Christian Rauth, Wiesbaden (DE)

(21) Appl. No.: 16/328,123

(22) PCT Filed: Aug. 25, 2017
(86) PCT No.: PCT/EP2017/070703

§ 371 Date: Feb. 25, 2019

(30) Foreign Application Priority Data
Aug. 25, 2016 (DE) 10 2016 115 770.8

(51) Int. Cl. G21F 1/12; G21F 3/00

(52) U.S. Cl. CPC G21F 1/125; G21F 3/00

(57) ABSTRACT

The invention relates to a radiation shielding element (101), which comprises at least one core (110) that shields from ionizing radiation and is surrounded by at least one protective layer (120), said protective layer (120) consisting of at least one outer layer (122) and at least one indicator layer (124). The invention also relates to an X-ray inspection unit (10) having a shielding device at the entrance (E) and/or exit (A) of radiation tunnel (12), said radiation shielding device consisting of a radiation shielding curtain which comprises a plurality of the claimed radiation shielding elements (101). The invention finally relates to methods (A; B; C) for assuring a minimum lead equivalence of a radiation shielding element (101), particularly for an X-ray inspection unit (10).

The present invention relates in general to protection from ionizing radiation, such as the radiation generated by X-ray tubes in X-ray inspection units. In particular the invention relates to a radiation shielding element for a radiation shielding curtain for use at an entrance and/or an exit of a radiation tunnel of an X-ray inspection system, wherein the radiation shielding element has an integrated replacement indicator.

### BACKGROUND OF THE INVENTION

Nondestructive inspection of objects by means of X-rays is a method known, for example, from materials testing, quality control in production, but also for safety testing at inspection sites at the access to safety areas or hazardous areas.

DE 101 31 407 A1 discloses an X-ray inspection system having an entrance and an exit to a radiation tunnel. A plurality of radiation shielding curtains are mounted at the entrance of the radiation tunnel of the inspection system, so that when a baggage item to be inspected is transferred to the inspection system or is discharged at the exit, no ionizing radiation can escape from the X-ray inspection system. Each radiation shielding curtain consists of a plurality of radiation shielding elements in the form of strips, lugs or slats.

US 2005/0185757 A also discloses an X-ray inspection system having a plurality of radiation shielding curtains.

The radiation shielding elements of the radiation shielding curtains are exposed to continuous wear accordingly during operation at the intended rate of processing baggage items due to the frictional attack occurring at the contact surfaces. This wear consists of material abrasion at the surface of the radiation shielding elements.

A radiation shielding element may be, for example, a strip-shaped element having a core material, such that the material thickness required for shielding from the ionizing radiation is dimensioned for a predetermined shielding level to be maintained. At high and low energy levels, heavy elements, i.e., elements having a high core valency, absorb ionizing radiation particularly good. Therefore, the X-ray shielding preferably contains lead. Lead as the core material is encapsulated with a protective layer to prevent lead abrasion.

The protective layer is worn away progressively due to the frictional attacks occurring during the intended regular use. As soon as the protective layer has been abraded at one location, the frictional attack is continued on the core material provided for shielding. In the case of lead, the resulting abrasion may result in unwanted contamination of the objects for inspection due to the so-called lead pencil effect associated with this. This is undesirable for obvious reasons. Even if the radiation shielding element were made of a material such as tin that is initially unobjectionable with regard to material abrasion, the friction attacks would at any rate result in a reduction of the material thickness required of the radiation shielding element for the specified minimum shielding. This is also unwanted, regardless of the material.

CN 202067569 U discloses a radiation shielding curtain having a lead core, which shields against ionizing radiation and is surrounded by a protective layer, wherein an indicator layer for indicating damage to the protective layer is arranged between the protective layer and the lead core on one of the two opposing side surfaces of the radiation shielding curtain.

### DISCLOSURE OF THE INVENTION

The object of the present invention is therefore to propose an improvement for radiation shielding elements so that it is possible to prevent the thickness of the material used for shielding against ionizing radiation from dropping below a predetermined minimum thickness and/or to prevent a transfer of this material to objects to be inspected.

This object is achieved with the features of the independent claims. Additional embodiments and advantageous refinements are defined in the following dependent claims. In these claims, features and details that are described in conjunction with the radiation shielding element according to the invention may of course also be seen in conjunction with the method according to the invention and reversed accordingly. Therefore, reference is made to the individual aspects mutually with respect to disclosure.

According to a first aspect of the invention, a radiation shielding element is proposed, having at least one core that shields against ionizing radiation such as X-rays. According to the invention, the protective layer consists of at least one outer layer and at least one indicator layer, which is preferably arranged between the core and the outer layer. In other words, in the simplest embodiment, the indicator layer is applied to the core that shields against the ionizing radiation, and the outer layer is applied to the indicator layer.

The outer layer preferably consists of a biologically and/or ecologically safe material. Basically, the outer layer may consist of a plurality of layers. For example, the outer layer may be a rubber layer, or rubberization may be applied in several passes. A coating layer may also be provided as the outermost layer of the outer layer.

In the simplest embodiment, the indicator layer may consist of a layer which can be differentiated from the outer layer in terms of color. Therefore, the indicator layer is visible from the outside at locations where the outer layer has been abraded, for example, due to constant friction attacks. This appearance of the colored indicator layer thus indicates directly visually, i.e., it signals, that the core material is now covered externally only by the indicator layer. In this simplest embodiment, when the indicator layer becomes visible, this serves as an indication that replacement of the radiation shielding element will be necessary imminently. The indicator layer is thus a visual replacement indicator integrated into the radiation shielding element.

In an advantageous refinement, the indicator layer may consist of a plurality of layers, wherein adjacent layers can be differentiated from one another by color. In the simplest embodiment, the indicator layer consists of exactly two adjacent layers, which are differentiated from the outer layer by color, as well as being differentiable from one another by color. If the two indicator layers have the same thickness and are also similar in abrasion behavior, then the period of time from when the first indicator layer becomes visible until the second indicator layer becomes visible can provide additional information with respect to how much time is available for replacement of the radiation shielding element from appearance of the second indicator layer. This period of time constitutes an additional safety margin in preventing the problems described in the introduction.

In a refinement of the preceding embodiment, the indicator layer consists of exactly three layers, which have a color different from the outer layer as well as are different in color from one another. In comparison with the two-layer embodiment of the indicator layer, the third indicator layer offers an additional safety margin. Appearance of the second indicator layer defines the time window accordingly as a function of the wear rate typical of this use location. The third indicator layer ensures that, if this period of time has been overestimated, there will be yet another indication and still no abrasion of core material. Thus, when the third indicator layer becomes visible, the radiation shielding element should be replaced promptly.

The at least one layer of the indicator layer may also be embodied as a textured layer. If the indicator layer consists of a plurality of layers, more than one of these layers may also be embodied as a textured layer.

In addition or as an alternative to color differentiability in comparison with a layer arranged above, a textured layer is constructed, so that a special texture (surface structuring, surface property) develops or a texture integrated into the structure is exposed as a result of the friction acting when used as intended at the surface. In other words, the textured layer is structured so that a special texture is formed at the surface due to abrasion over a period of time as a result of the friction acting at the surface because of wear on the layer due to friction.

For example, the textured layer may be designed so that the layer has regions of at least two different abrasion-resistant materials. Because of the difference in abrasion resistance, the special structure is formed due to different wear rates accordingly. For example, the regions of different abrasion resistance may be arranged in such a way that certain surface structures, e.g., ribs, nubs, honeycombs or the like are formed as a special texture due to the difference in speed of the resulting abrasion. Alternatively or additionally, a different structured material that is exposed by the wear or “fraying” may be incorporated into a layer of the indicator layer to form the textured layer.

First, this textured layer may be formed in such a way that ribs, nubs or honeycombs that are visible are formed due to abrasion. This texture, which then becomes visible, may serve as a “visual indicator” that can be detected visually.

Alternatively or additionally, the textured structure may be designed so that when the textured layer is ground or glides over a surface of an object having a sufficient surface hardness, a perceptible noise is produced. A textured layer having certain surface structures, e.g., grids, webs, honeycombs, nubs, grooves or the like, can generate a recognizable noise such as a typical rattling as an “acoustic replacement indicator” on an object for inspection, for example, the edges of a suitcase. In this way the indicator layer can supply the “acoustic replacement indicator” in addition or as an alternative to the functionality of the “visual replacement indicator.”

In this context, it should be pointed out that “abrasion resistance” here is understood to refer to the resistance of a solid surface to mechanical stress, in particular friction. The abrasion resistance of a material is determined essentially from the surface properties of the material, mainly its roughness and hardness. The abrasion resistance can be determined by grinding or sand blasting, for example.

The material of the core (core material) equipped for shielding against ionizing radiation may contain or consist entirely of at least one of the following materials: pure lead, lead oxide, tin, tin oxide, lead vinyl, lead-rubber, barium, samarium.

The at least one outer layer may contain or consist of at least one of the following materials: rubber, PVC, protective coating.

The at least one indicator layer may consist of one of the materials mentioned for the outer layer, for example, wherein suitable colored pigments are added to the material for the desired coloration. The one or more textured layers of the indicator layer may have regions of at least two materials with a different abrasion resistance, wherein the regions are arranged in the plane of the layer in such a way that they correspond to the textured elements (grids, webs, honeycombs, nubs, grooves, etc.) to be formed due to the different abrasion rates.

In one special embodiment, the at least one outer layer may consist of the material of the core. This variant is suitable in particular when a biologically safe material, for example, lead-rubber or a material containing tin or tin oxide is used as the core material, in which the abrasion cannot result in unwanted contamination of the objects inspected. If the outer layer is made of the material of the core, which also shields against ionizing radiation, then a fundamentally greater shielding against ionizing radiation is achieved due to the thickness of the material of the outer layer. The minimum shielding of the radiation shielding element, which must absolutely be maintained, is ensured by the thickness of the material of the core which can be monitored with the help of the at least one indicator layer as an integrated replacement indicator. Here again, a coating layer may be provided as the outermost layer of the outer layer.

In certain embodiments the at least one indicator layer may also consist of the material of the core, wherein to differentiate the color of the at least one outer layer and/or the core, suitable colored pigments are added. This variant is also preferably suitable for cores consisting of a biologically safe material whose abrasion does not result in unwanted contamination of objects to be inspected.

In all embodiments, the core of the radiation shielding element has a material thickness which corresponds to a predetermined lead equivalence. The required minimum thickness or material thickness of the core, which is equipped for shielding against ionizing radiation, depends at first on the intensity of the radiation source to be shielded and the associated emission values. A maximum allowed emission value of an X-ray inspection system for example, is stipulated by statutory regulations and from this it is possible to determine directly the required shielding of such a unit. To describe the shielding, a value known as the lead equivalence is used. The higher the lead equivalence, the lower is the intensity of the ionizing radiation emitted on the side of the radiation shielding element facing away from the radiation source.

In preferred embodiments, the radiation shielding element is designed in the form of strips, wherein the length of the strips is greater than the width of the strips, and the thickness of the strips is much smaller than the width of the strips. For use as slats in a radiation shielding curtain for a radiation tunnel of an X-ray inspection system, the strip width is preferably approximately 90 mm, the strip height is approximately the height h of the radiation tunnel plus 30 mm, and the strip thickness is approximately 2.5 mm.

A second aspect of the invention relates to an X-ray inspection system having a radiation shielding device at the entrance and/or at the exit of a radiation tunnel, wherein the radiation shielding device consists of a radiation shielding curtain having a plurality of radiation shielding elements according to the first aspect of the invention.

A third aspect of the invention relates to a method for ensuring a minimum equivalence of the radiation shielding device of an X-ray inspection system such as an X-ray inspection system according to the second aspect of the invention, for example.

In a first variant (A) of the method, the radiation shielding elements have a single indicator layer and one or all of the radiation shielding elements are replaced at the latest after a predetermined period of time, namely as soon as this single indicator layer becomes visible.

In a second variant (B) of the method, the radiation shielding elements have a first indicator layer and a second indicator layer, wherein a period of time is detected, which is determined from the point in time when the first indicator layer beneath the outer layer becomes visible until the point in time when the second indicator layer beneath the first indicator layer becomes visible. Some or all of the radiation shielding elements thus affected are replaced at the latest after a period of time corresponding to the detected time window or a time window that has been reduced by a safety margin, starting from the time when the second indicator layer becomes visible.

In a third variant (C) of the method, as a refinement of the second variant, the indicator layer has another third indicator layer beneath the second indicator layers. The affected radiation shielding elements or all of these elements are then replaced immediately as soon as the third indicator layer becomes visible.

In other words, one or all of the radiation shielding elements may be replaced:

(i) in variant (A): as soon as a first indicator layer, which is arranged beneath the outer layer, becomes visible on one of the radiation shielding elements, or

(ii) in variant (B): after a time window starting with the second indicator layer, which is arranged beneath the first indicator layer, becoming visible, wherein the length of the time window corresponds to the period of time from the point in time when the first indicator layer becomes visible to the point in time when the second indicator layer becomes visible, or

(iii) in variant (C): as soon as a third indicator layer, which is arranged beneath the second indicator layer, becomes visible.

### PREFERRED EMBODIMENTS

Additional advantages, features and details of the invention are derived from the following description, in which embodiments of the invention are described in detail with reference to the drawings. The features mentioned in the claims and the description may be essential to the invention either individually or in any combination. Likewise, the features mentioned above and those to be explained here below may also be used alone or several together may be used in any combinations. Identical components or those having the same function are provided with the same reference numerals. The terms “left,” “right,” “top” and “bottom” used in the description of the embodiments relate to the drawings in an orientation with figure designations that can be read normally or reference numerals that can be read normally. The embodiments illustrated and described here are not to be understood as conclusive but instead have the nature of examples to illustrate the invention. The detailed description serves to inform those skilled in the art and therefore known structures and methods are not illustrated or explained in detail in the description, so as not to make it difficult to understand the present description.

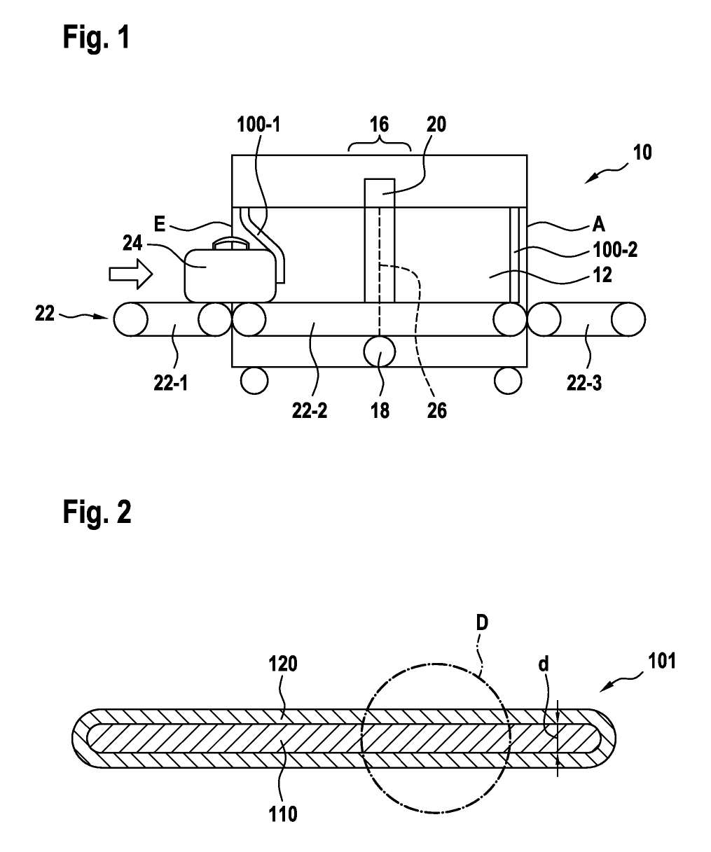

FIG. 1 shows an X-ray inspection system in a sectional diagram from the side with a radiation shielding device consisting of a plurality of radiation shielding elements.

FIG. 2 shows a cross section through a radiation shielding element.

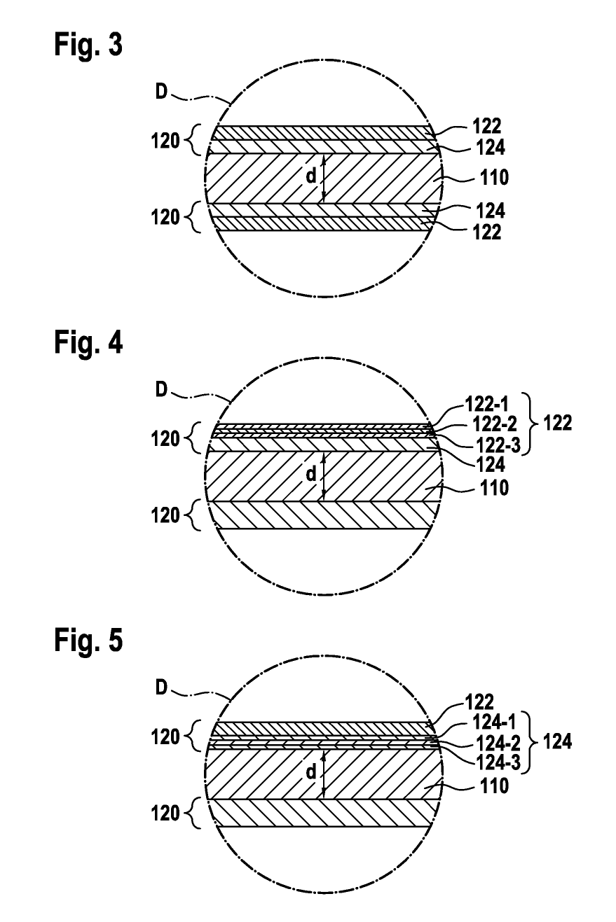

FIG. 3 shows a detail D of FIG. 2 with a more detailed diagram of the protective layer with at least one outer layer and at least one indicator layer.

FIG. 4 shows the detail D of FIG. 3 with a more detailed diagram of the outer layer.

FIG. 5 shows the detail D of FIG. 2 with a more detailed diagram of the indicator layer.

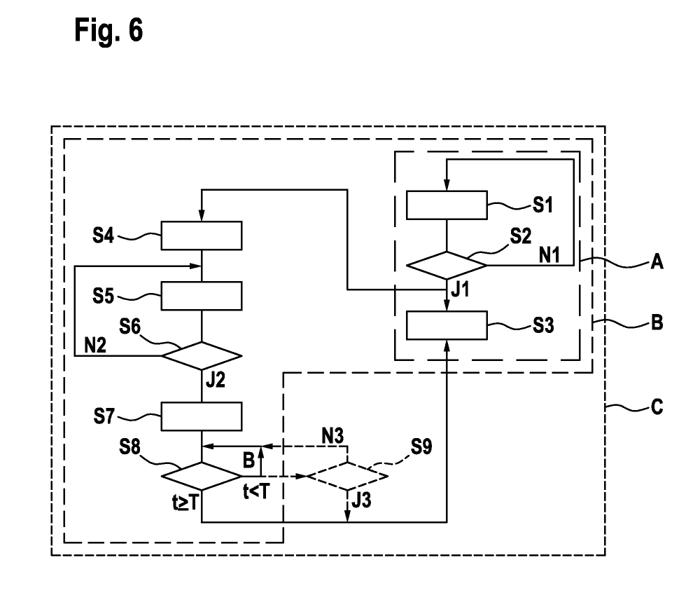

FIG. 6 shows a schematic flow chart of a method for securing a minimum lead equivalence of a radiation shielding device of an X-ray inspection system.

FIG. 1 shows an X-ray inspection system 10, such as that used for example, for nondestructive inspection of baggage items at the point of access to security areas at airports. The inspection system 10 has a radiation shielding curtain 100-1, 100-2 for ionizing radiation at an entrance E and an exit A of a radiation tunnel 12. Between the two radiation shielding curtains 100-1, 100-2 there is a radiation region 16, in which at least one radiation source 18, for example, an X-ray tube and at least one detector arrangement are arranged. A transport system 22 leading through the radiation tunnel 12 consists of three conveyor belts 22-1, 22-2, 22-3 for conveying a baggage item 24 through the radiation channel 12. The baggage item 24, represented as a suitcase in FIG. 1, is conveyed by the transport system 22 through the X-ray inspection system 10. In the passage, the baggage item 24 is irradiated row by row by an X-ray beam span 26 generated by the radiation source 18, and the intensity of the X-ray radiation not absorbed by the baggage item 24 is detected by the detector array 20.

To ensure a reduction in ionizing radiation emitted by the X-ray inspection system in accordance with statutory requirements, the radiation shielding elements of the radiation shielding curtains 100-1, 100-2 are each made of a material which has the thickness required for the desired extent of shielding and is suitable for shielding against ionizing radiation, wherein the shielding can be indicated by the number of the lead equivalence. The lead equivalence corresponds to the layer thickness of lead which exhibits the same shielding effect with respect to ionizing radiation as a given layer thickness of the material actually used.

With regard to FIGS. 2 through 5 which are described below it should be pointed out that the diagram in the figures is labeled with regard to the thickness of the layers. This serves only to improve the diagram and for the sake of illustration.

FIG. 2 shows a radiation shielding element 101, for example in the form of a slat, one of the radiation shielding curtains 100-1, 100-2 in cross section. The radiation shielding element 101 consists of a core 110 surrounded by at least one protective layer 120, i.e., encapsulated by it. The core 110 has a layer thickness d which achieves the predetermined shielding effect with respect to ionizing radiation. The protective layer 120 has a layer structure to be explained in greater detail below, as first explained in general with reference to FIG. 3.

FIG. 3 shows the detail D from FIG. 2 on an enlarged scale and shows the core 110 with the required material thickness d and the protective layer 120 on both sides of the core 110 so that the protective layer 120 consists of an outer layer 122 and an indicator layer 124.

In FIG. 4, which corresponds essentially to FIG. 3, it is shown in detail in comparison with FIG. 3 that the outer layer 122 may consist of a plurality of layers, namely three layers 122-1, 122-2, 122-3 in the embodiment illustrated here. Likewise, for simplification, only the layer structure of the upper outer layer 122 is shown because the core 110 is encapsulated so the design of the lower outer layer is identical.

The outer layer 122 may be a rubber layer which is created in multiple steps in production and thus leads to the multilayer structure with more than one layer as illustrated here. The outer layers may basically be identical in structure. In other words, the outer layer may consist of a single layer or any number of similar sub-layers. In certain embodiments the outermost layer 122-1 of the outer layer 122 is a coating layer.

FIG. 5, which corresponds essentially to FIGS. 3 and 4 shows additionally in detail that the indicator layer 124 may be constructed of a plurality of layers. Also, for simplification, only the layer structure of the upper indicator layer 124 is shown. Since the core 110 is encapsulated, the structure of the lower indicator layer is identical. The possible functions and possible embodiments of the indicator layer associated therewith will be explained below.

FIG. 5 shows the indicator layer 124 consisting of three layers 124-1, 124-2, 124-3. Basically, however, three main embodiments are proposed as explained below.

In a first embodiment, the indicator layer 124 consists of exactly one layer 124-1. In a second embodiment, the indicator layer 124 consists of exactly two adjacent layers 124-1 and 124-2. In a third embodiment, the indicator layer 124 consists of exactly three adjacent layers 124-1, 124-2, 124-3. In all embodiments, the indicator layer 124 consists of one or more layers 124-1, 124-2, 124-3, which can be differentiated from the outer layer 122 and optionally from one another essentially by color and/or acoustically. The function of the indicator layer 124 is explained in the following context on the basis of FIG. 6 and a method for ensuring a minimum lead equivalence of the radiation shielding elements 101, for example the X-ray inspection system 10 of FIG. 1.

With regard to the core material, it should be pointed out that it preferably consists of a material and/or a material mixture, at least one component of which is suitable for providing the desired shielding properties for ionizing radiation. For example, the core may be made of pure lead or pure tin or may consist of a blend of materials together with lead oxide and/or tin oxide such as lead vinyl or lead-rubber. For example, the core may be made of rolled elemental lead. Alternatively, elemental lead, i.e., pure lead or lead oxide or elemental tin or tin oxide, or alternatively, a mixture of the preceding substances in powder form may be mixed with a carrier material, for example, PVC, natural rubber or synthetic rubber. Sheeting produced from this material can then be cut to size in a suitable shape to be used as the core 110 for radiation shielding elements 101.

As already described in the introduction, depending on the structure of the core 110 it may be problematical if the objects for inspection become contaminated with abraded core material due to attack by friction on the objects for inspection conveyed through the inspection system. Alternatively, the attack by friction taking place continuously during operation as intended can lead to a reduction in the material thickness of the radiation shielding elements, although it should not fall below a predetermined level required for the shielding effect.

To prevent one or both problems, it is proposed here that the core 110 of the radiation shielding elements 101 should be encapsulated in a protective layer 120, which is described above in conjunction with FIGS. 3 to 5 and has at least one indicator layer 124 in addition to the at least one outer layer 122. Depending on the number of indicator layers, additional advantages can be achieved. On the basis of the flow chart in FIG. 6, the possible functions and advantages of a single layer or multilayer indicator layer 124 will now be explained.

The protective layer 120 having at least one outer layer 122 and at least one indicator layer 124 is exposed to constant attack by friction during operation as intended. The operation as intended corresponds to step S1 in the flow chart.

In a monitoring step S2 for example by means of visual inspection, the radiation shielding elements 101 are visually inspected to ascertain whether the at least one indicator layer 124 has become visible due to abrasion of the at least one outer layer 122. As long as it is ascertained in step S2 that the indicator layer 124 is not visible, the method returns to step S1 via the branch N1.

In the first embodiment A, the indicator layer 124 consists of only a single indicator layer 124-1. In other words, as soon as it is ascertained in step S2 that this single indicator layer 124-1 has become visible, the method goes directly via branch J1 to step S3, where replacement of the affected radiation shielding element 101 takes place promptly or is at least initiated.

In the second embodiment A, the indicator 124 consists of at least two indicator layers 124-1, 124-2, which are arranged one above the other and can be differentiated from one another by color. It is advantageous here, if the second indicator layer 124-2, which is closer to the core 110, is at least exactly as thick as the first indicator layer 124-1 situated above it. This has the advantage that it is possible to expect that the abrasion of the second indicator layer 124-2 occurring during operation will last almost exactly as long as abrasion of the first indicator layer 124-1. In the second embodiment B, the method after step S2 does not proceed to step S3, with the first indicator layer 124-1 becoming visible, but instead proceeds to step S4.

In step S4, a timer is started first. In the simplest case, this may consist of recording the point in time when the first indicator layer 124-1 becomes visible. It would also be conceivable for a functionality of the system control to implement an electronic timer, which can be started by a corresponding input.

Step S4 is followed by step S5, which corresponds essentially to step S1, i.e., the use of the radiation shielding elements 101 as intended, in which the usual attack by friction and thus abrasion of the first indicator 124-1 that has become visible takes place. Accordingly, in step S6, which corresponds essentially to step S2, there is a check on whether or not the second indicator layer 124-2, which is arranged beneath the first indicator layer 124-1, has become visible. As long as the second indicator layer 124-2 has not become visible, the method returns to step S5 via the branch N2.

As soon as the second indicator layer 124-2 has become visible, the method proceeds via branch J2 to step S7, in which essentially the point in time when the second indicator layer 124-2 becomes visible is detected by stopping the manual or electronic timer. Therefore, this determines the period of time T during which the first indicator layer 124-1 has become abraded due to use as intended and as customary in that location.

The period of time T thereby ascertained provides a measure of the expected duration of abrasion of the second indicator layer 124-2. Therefore, the user of the system has approximately the period of time T available until the radiation shielding element 101 thereby affected must be replaced. In other words, when the period of time T for abrasion of the first indicator layer 124-1 has lasted approximately one month, it is to be expected that the second indicator 124-2, which has approximately the same thickness will also withstand approximately one month. Therefore, the method proceeds from step S7 to step S8 with a second timer, which ascertains whether the available time T has elapsed. A safety margin can advantageously be provided, consisting of the fact that a percentage P % of less than 100% of the time T determined is assumed for the period of time measured by the timer in step S8. In the variant “B”, the branch t<T of the method returns directly to step S8, so the path is additionally labeled as “B”.

As soon as it is ascertained in step S8 that the time T has elapsed (optionally reduced by P %), the method goes to step S3, in which the radiation shielding element 101 affected is replaced promptly.

In a particularly advantageous embodiment C, the indicator layer 124 consists of three layers 124-1, 124-2, 124-3, which can be differentiated from one another by color, as shown in FIG. 5. Thus, after abrasion of the second indicator layer 124-2, a further safety margin is available by means of the third indicator layer 124-3, indicating, for example, premature abrasive loss of the second indicator layer 124-2 before the end of the time window T. Therefore, contamination of objects for inspection due to abrasion of the core 110 or an unacceptable reduction in the thickness of the material of the core 110 can be ruled out even more reliably.

In the third embodiment C, another step S9, which is integrated into the timer loop of step S8 (instead of the path labeled as “B”) is also provided in this method, and in addition to the end of time T (optionally reduced by P %), there is also a check on whether the third indicator layer 124-2 has become visible. If the third indicator layer 124-3 becomes visible before the end of time T (optionally reduced by P %), then the method returns by way of the path J3 to step S3, in which the radiation shielding element 101 in question is replaced.

Alternatively, the method C may be designed, so that it fundamentally always takes place by way of step S9, so that even after the end of time T (optionally reduced by P %), the method advances to step S3 only when the third indicator layer 124-3 has become visible. Therefore, the protective layer 120 surrounding the core 110 is utilized to the maximum extent.

Since the third indicator layer 124-3 actually functions only as a “last warning,” this layer may be designed to be thinner than the first and second indicator layers 124-1 and 124-2.

As explained in the introduction, one layer of the indicator layer may be designed as a textured layer. This can be used in principle in all the embodiments described above. The textured layer with an acoustic indicator functionality may also be used in all embodiments to particular advantage. In the embodiments having two or three layers in the indicator layer, the acoustic indicator functionality is preferably integrated into the second or third layers only by means of texture.

1.-15. (canceled)

16. A radiation shielding element, comprising:
at least one core;
at least one protective layer surrounding the at least one core, the at least one protective layer configured to shield the at least one core against ionization radiation, wherein the at least one protective layer comprises:
at least one outer layer; and
at least one indicator layer.

17. The radiation shielding element of claim 16, wherein the outer layer consists of a plurality of layers.

18. The radiation shielding element according to claim 16, wherein the indicator layer consists of at least one layer, which can be differentiated by color from the outer layer.

19. The radiation shielding element according to claim 16, wherein the indicator layer consists of two layers or three layers and adjacent layers can be differentiated from one another by color.

20. The radiation shielding element according to claim 16, wherein at least one layer of the indicator layer is a textured layer, which is structured in addition or as an alternative to the color differentiability in comparison with a layer arranged beneath it, so that a texture is formed due to abrasion at the surface during use as intended, this texture being visually detectable and/or designed in such a way that a noise is generated when the textured layer is ground over a surface of an object having a sufficient surface hardness.

21. The radiation shielding element according to claim 16, wherein at least the core contains or consists of at least one of the following materials: pure lead, lead oxide, tin, tin oxide, lead vinyl, lead-rubber, barium, samarium.

22. The radiation shielding element according to claim 16, wherein the protective layer contains or consists of at least one of the following materials: rubber, PVC, protective coating.

23. The radiation shielding element according to claim 16, wherein the at least one outer layer is made of the same material as the core.

24. The radiation shielding element according to claim 16, wherein the at least one indicator layer is made of the same material as the core, wherein colored pigments that make the layer identifiable are added to the material of the indicator layer for differentiation of the color of the at least one outer layer and/or the core.

25. The radiation shielding element according to claim 16, wherein the core has a thickness of the material that corresponds to a predetermined lead equivalence.

26. The radiation shielding element according to claim 16, wherein the radiation shielding element is in the form of strips, the length of a strip being greater than the width of a strip, and the thickness of the strip being substantially smaller than the width of the strip.

27. The radiation shielding element according to claim 26, wherein the width of the strip is approximately 90 mm and the height of the strip is approximately 30 mm longer than the height of a radiation tunnel on which the radiation shielding element is to be installed, and the thickness of the strip is approximately 2.5 mm.

28. An X-ray inspection system, comprising:
a radiation tunnel comprising an entrance and an exit;
a radiation shielding device located at least at one of: the entrance of the radiation tunnel or the exit of the radiation tunnel, the radiation shielding device comprising:
a radiation shielding curtain comprising a plurality of radiation shielding elements, wherein the plurality of shielding elements comprises one or more indicator layers, wherein one or more of the plurality of shielding elements is replaced after a predetermined period of time based at least in part on visibility indication in at least one of the one or more indicator layers.

29. The X-ray inspection system of claim 28, wherein the shielding elements comprise:
at least one core;
at least one protective layer surrounding the at least one core, the at least one protective layer configured to shield the at least one core against ionization radiation, wherein the at least one protective layer comprises: at least one outer layer and the one or more indicator layer.

30. A method for ensuring a minimum lead equivalence of a radiation shielding element, comprising:
replacing one or more radiation shielding elements in a radiation shielding curtain after a predetermined period of time, based at least in part on visibility indication in at least one or more indicator layers.

31. The method of claim 29, wherein one or more radiation shielding elements has a single indicator layer, and wherein one or more of the radiation shielding elements are replaced after a predetermined period of time, based at least in part on visibility indication of a first indicator of the one or more indicator layers.

32. The method of claim 29, wherein the one or more indicator layers comprises a first indicator layer and a second indicator layer, and wherein the one or more of the radiation shielding elements are replaced after a second predetermined period of time, based at least in part on an elapsed time between when the first indicator layer becomes visible and when the second indicator layer becomes visible, the second indicator layer being situated beneath the first indicator layer.

33. The method according to claim 29, wherein the first indicator layer is situated beneath an outer layer.

34. The method according to claim 29, wherein the one or more indicator layers has a third indicator layer beneath the second indicator layer, and wherein one or more of the radiation shielding elements are replaced when the third indicator layer becomes visible.

35. The method according to claim 29, wherein the radiation shielding curtain forms part of an X-ray inspection system, the X-ray inspection system comprising:
a radiation tunnel comprising an entrance and an exit;
a radiation shielding device located at least at one of: the entrance of the radiation tunnel or the exit of the radiation tunnel, the radiation shielding device comprising: and
the radiation shielding curtain comprising the one or more radiation shielding elements, wherein the one or more shielding elements comprises the one or more indicator layers.
